(19) United States
(12) Patent Application Publication
(10) Pub. No.: US 2008/0116875 A1
(43) Pub. Date: May 22, 2008

(54) Systems, apparatus and methods relating to bandgap circuits

(76) Inventor: Fan Yung Ma, Singapore (SG)

Correspondence Address: SLATER & MATSIL LLP, 17950 PRESTON ROAD, SUITE 1000, DALLAS, TX, 75252, US

(21) Appl. No.: 11/600,580

(22) Filed: Nov. 16, 2006

(51) Int. Cl. G05F 3/16; G05F 3/02

(52) U.S. Cl. 323/313; 327/539

(57) ABSTRACT

A system includes a bandgap reference voltage circuit, a plurality of trimming resistors, a plurality of trimming switches to connect the bandgap reference voltage circuit to one or more of the plurality of trimming resistors, and an output terminal to connect to at least one of the bandgap reference voltage circuit and the plurality of trimming resistors. The system may provide a trimmed reference voltage independent of at least one of the resistance of any of the plurality of trimming switches and the voltage across any of the plurality of trimming switches.

### TECHNICAL FIELD

The present invention relates to a circuit for providing a voltage, and relates particularly, though not solely, to a bandgap reference voltage circuit.

### BACKGROUND

It is useful in the field of electronic circuits to provide a constant and stable reference voltage. For example reference voltages of around 1.25V are common as this is close to the theoretical bandgap of silicon at 0 K.

An example prior art system that provides a reference voltage is a “bandgap reference voltage circuit”. Various methods have been proposed including those by Widlar, R., “New Developments in IC Voltage Regulators,” IEEE Journal of Solid-State Circuits, Vol. SC-6, pp. 2-7, February 1971; K. Kuijk, “A Precision Reference Voltage Source,” IEEE Journal of Solid-State Circuits, Vol. SC-8, pp. 222-226, June 1973; and H. Banba, et. al., “A CMOS Bandgap Reference Circuit with sub-1-V Operation,” IEEE Journal of Solid-State Circuits, Vol. 34, pp. 670-674, May 1999.

### BRIEF DESCRIPTION OF THE DRAWINGS

Exemplary embodiments will now be described for the sake of example only with reference to the drawings, in which:

FIG. 1 shows a circuit diagram of a bandgap circuit with a trimming circuit according to an example embodiment;

FIG. 2 shows a circuit diagram of a bandgap circuit with a trimming circuit according to a further example embodiment;

FIG. 3 shows a circuit diagram of a bandgap circuit with a trimming circuit according to a still further example embodiment;

FIG. 4 shows a flow diagram for a method of trimming R₄ in FIG. 1 or FIG. 2;

FIG. 5 shows a flow diagram for a method of trimming R₄ in FIG. 3; and

FIG. 6 shows a flow diagram for a method of trimming R₃ in FIG. 3.

### DETAILED DESCRIPTION OF ILLUSTRATIVE EMBODIMENTS

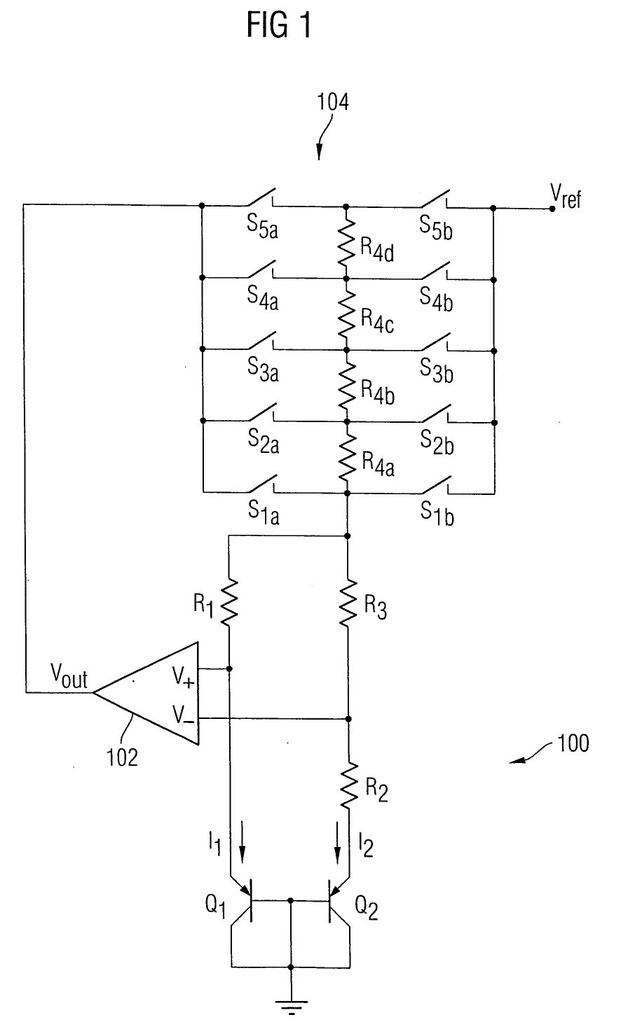

Referring to FIG. 1 a bandgap circuit 100 is shown according to an exemplary embodiment. An operational amplifier OPAMP 102 has a positive input terminal V₊ a negative input terminal V and an OPAMP output Vₒᵤₜ. A first resistor R₁ is connected to the positive input terminal V₊. A second resistor R₂ is connected to the negative input terminal V₋. A third resistor R₃ is connected between the negative input terminal V and the first resistor R₁. A first PNP bipolar transistor Q₁ has the emitter connected to the positive input terminal V₊, the collector and the base connected to ground, and emitter current I₁. A second PNP bipolar transistor Q₂ has the emitter connected to the second resistor R₂, the collector and the base connected to ground, and emitter current I₂. The OPAMP 102 operates to equalize the voltage at its inputs V₊−V₋˜0V, as shown in equation 1:

I₁*R₁=I₂*R₃ (1)

I₁ and I₂ are the currents through the emitter of each bipolar transistor. ΔV_{EB} is the difference between V_{EBQ1} and V_{EBQ2}, and can be calculated according to equation (2):

$$\begin{matrix}Δ {V}_{EB} = {V}_{EB 1} - {V}_{EB 2} \\ = {I}_{2} * {R}_{2}\end{matrix} \qquad ( 2 )$$

Therefore, the temperature stability of the bandgap circuit output voltage V_{ref} without g (i.e R₄=0Ω) may be analyzed using equation (3):

$$\begin{matrix}{V}_{ref} = {V}_{EB 1} + {I}_{2} * {R}_{3} \\ = {V}_{EB 1} + ( Δ {V}_{EB} / {R}_{2} ) * {R}_{3} \\ = {V}_{EB 1} + ( {R}_{3} / {R}_{2} ) * {V}_{t} * Ln [ ( {R}_{3} / {R}_{1} ) * ( {I}_{S 2} / {I}_{S 1} ) ]\end{matrix} \qquad ( 3 )$$

In Equation (3), Vₜ is the thermal voltage (eg:˜26 mV@ 25° C.) and I_{S} is the saturation current coefficient of Q₁ and Q₂. The bandgap circuit may have an operating configuration, for example equal bias currents (I₁=I₂ R₁=R₃) and bipolar device ratio scaling (I_{S2}/I_{S1}=N) or bias current scaling (I₁=N*I₂, R₃/R₁=N, I_{S1}=I_{S2}). In those configurations the circuit operation is characterized by Equation (4):

V_{ref}=V_{EBQ1}+(R₃/R₂)*Vₜ*Ln(N) (4)

In Equation (4), V_{BEQ1} (“CTAT component”) is complementary to absolute temperature (CTAT). As such, the voltage reduces with increasing temperature and has approximate proportionally within small operating temperature ranges. The right hand term in Equation (4) (R₃/R₂*Vₜ*Ln(N)) (“PTAT component”), the Vₜ is proportional to absolute temperature (PTAT) so that the voltage increases with increasing temperature and has approximate proportionally within small operating temperature ranges. Thus, if the ratios between the resistor are appropriately designed, the CTAT component and the PTAT component will cancel each other out over a given temperature range, to achieve high temperature stability of V_{ref} eg: zero temperature coefficient.

In practice the precision or accuracy of bandgap circuits may be limited by manufacturing variations eg: variations in VBE, and bipolar and resistor matching.

FIG. 1 shows a trimming circuit 104 connected between the output of the OPAMP Vₒᵤₜ and the common point of R₁ and R₃. In operation the trimming circuit 104 may provide a predetermined trimming resistance that compensates for the voltage magnitude and/or the temperature coefficient.

The trimming circuit 104 comprises a series of trim resistors R₄ₐ-R_{4d} connected to the common point between R₁ and R₃. A series of switch pairs S₁-S₅ have the first set of switches S₁ₐ-S₅ₐ connected between the output of the OPAMP Vₒᵤₜ and the trim resistors, and the second set of switches S_{1b}-S_{5b} connected between the trim resistors and the output terminal V_{ref}.

The trimming of R₄ causes an adjustment of the positive temperature coefficient component according to Equation (5):

$$\begin{matrix}{V}_{ref} = {V}_{EB 1} + {I}_{2} * {R}_{3} + ( {I}_{1} + {I}_{2} ) * {R}_{4} \\ = {V}_{EB 1} + {I}_{2} * ( {R}_{3} + {R}_{4} ) + {I}_{1} * {R}_{4} \\ = {V}_{EB 1} + {I}_{2} * ( {R}_{3} + {R}_{4} ) + {I}_{2} * R 4 * {R}_{3} / {R}_{1} \\ = {V}_{EB 1} + {I}_{2} * [ {R}_{3} + {R}_{4} * ( 1 + {R}_{3} / {R}_{1} ) ] \\ = {V}_{EB 1} + ( Δ {V}_{EB} / {R}_{2} ) * [ {R}_{3} + {R}_{4} * ( 1 + {R}_{3} / {R}_{1} ) ] \\ = {V}_{EB 1} + [ ( {R}_{3} / {R}_{2} ) + ( {R}_{4} / {R}_{2} ) * \{ 1 + ( {R}_{3} / {R}_{1} ) \} ] * {V}_{t} * Ln ( N )\end{matrix} \qquad ( 5 )$$

In Equation (5), R₄ is the value of the resistance between the selected connection point/closed switch and the common point between R₁ and R₃.

One of the first set of switches S₁ₐ-S₅ₐ will carry the current that flows through R₄. These switches are termed current force switches. The current force switches S₁ₐ-S₅ₐ do not affect the output voltage since the switches are not in the sense path of the V_{ref} output terminal. By connecting the output terminal V_{ref} to a high impedance load, any parasitic voltage drop across the second set of switches S_{1b}-S_{1b} will be negligible. The second sets of switches are termed the voltage sense switches. The circuit in FIG. 1 is configured so that the output voltage V_{ref} is independent of the resistance and/or the voltage drop across any of the current force and voltage sense switches. The circuit in FIG. 1 is also configured so that the bipolar bias currents I₁ and I₂ do not become unmatched by trimming R₄. In order to ensure correct performance over the operating range of temperatures, R₂ is fixed and R₁ and R₃ are tracking. The voltage supply to the OPAMP, such as OPAMP 102 in FIG. 1, should provide enough headroom for the voltage drop across the current force switches.

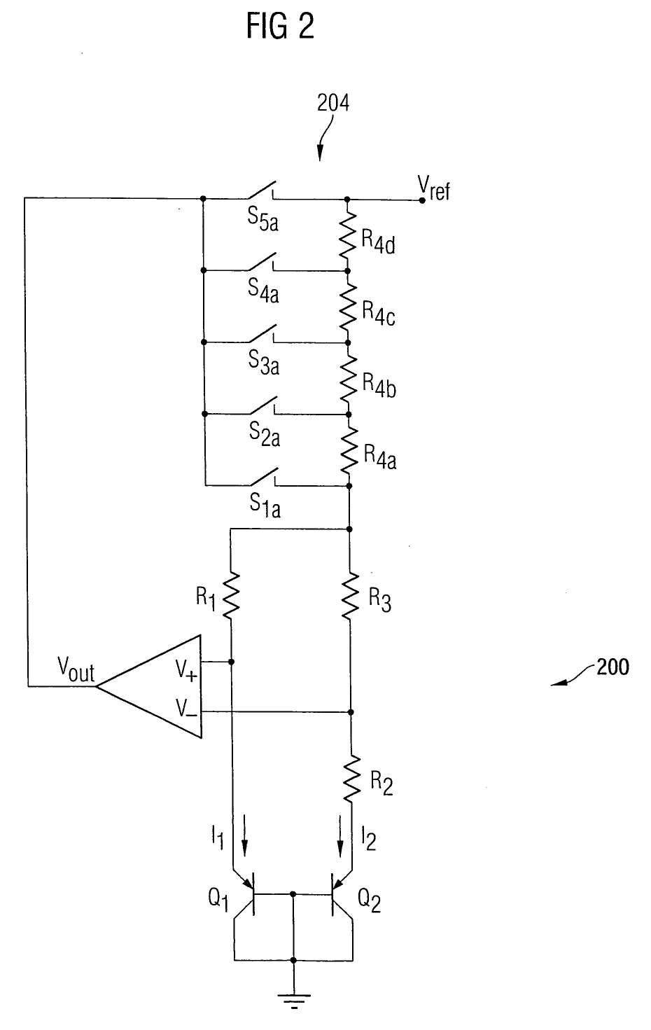

Referring to FIG. 2, a bandgap circuit 200 is shown according to a further exemplary embodiment. The bandgap circuit 200 operates similarly to the bandgap circuit 100 shown in FIG. 1. FIG. 2 shows a trimming circuit 204 connected between the output of the OPAMP Vₒᵤₜ and the common point of R₁ and R₃. In operation the trimming circuit 204 may provide a predetermined trimming resistance R₄ that compensates for the voltage magnitude and/or the temperature coefficient.

The trimming circuit 204 comprises a series of trim resistors R₄ₐ-R_{4d} connected between the common point between R₁ and R₃ and the output terminal V_{ref}. A series of switches S₁-S₅ are connected between the output of the OPAMP Vₒᵤₜ and the trim resistors. By connecting the output terminal V_{ref} to a high impedance load, any parasitic voltage drop across the non current-carrying R₄ resistors, between the output terminal V_{ref} and the selected connection point/closed switch, will be negligible. The circuit in FIG. 2 is configured so that the output voltage V_{ref} is independent of the resistance and/or the voltage drop across any of the switches.

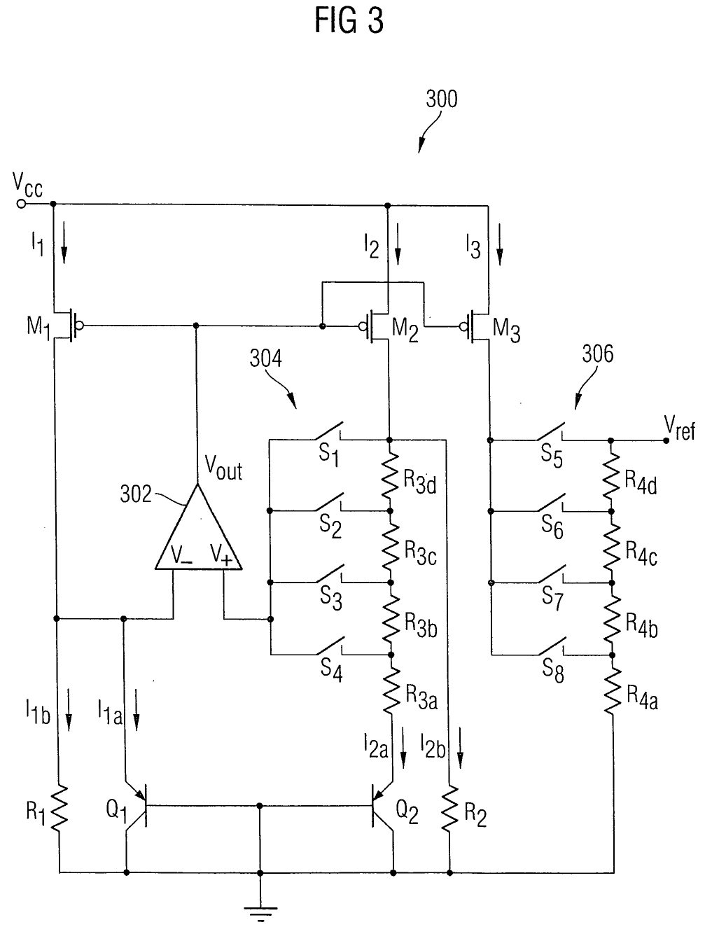

Referring to FIG. 3 a bandgap circuit 300 is shown according to a still further exemplary embodiment. An operational amplifier OPAMP 302 has a positive input terminal V₊ a negative input terminal V₋ and an OPAMP output Vₒᵤₜ. A first PMOS transistor M₁ has its drain terminal connected to the negative input terminal V₋, its source terminal connected to a supply V_{CC}, its gate terminal connected to the OPAMP output Vₒᵤₜ, and drain current I₁. A first resistance R₁ is connected to the negative input terminal V₋, with resistor current I_{1b}. A first PNP bipolar transistor Q₁ has its emitter terminal connected to the negative input terminal V₋, its collector terminal and its base terminal connected to ground, and emitter current I₁ₐ. A second PMOS transistor M₂ has its source terminal connected to the supply V_{CC}, its gate terminal to connect to the OPAMP output Vₒᵤₜ, and drain current I₂. A second resistance R₂ is connected to the drain terminal of the second PMOS transistor M₂ with resistor current I_{2b}. A second PNP bipolar transistor Q₂ has its emitter terminal connected to the second end of the third plurality of trimming resistors, its collector terminal and its base terminal connected to ground, and an emitter current I₂ₐ. A third PMOS transistor M₃ has its source terminal connected to the supply V_{CC}, its gate terminal connected to the OPAMP output Vₒᵤₜ, and a drain current I₃.

FIG. 3 shows a first trimming circuit 304 connected between the second PMOS transistor M₂ and the OPAMP 302. In operation the trimming circuit 304 may provide a predetermined trimming resistance R₃ that compensates for the temperature coefficient.

The first trimming circuit 304 comprises a third plurality of trimming resistors R₃ that are connected at a first end to the drain terminal of the second PMOS transistor M₂. A first plurality of trimming switches S₁-S₄ is connected between the positive input terminal V₊ and a selected connection point between two of the third plurality of trimming resistors R₃.

FIG. 3 shows a second trimming circuit 306 connected between the third PMOS transistor M₃ and ground. In operation the trimming circuit 306 may provide a predetermined trimming resistance R₄ that compensates for the output voltage magnitude.

The second trimming circuit 306 comprises a fourth plurality of trimming resistors R₄ that are connected at a second end to ground. A second plurality of trimming switches S₅-S₈ are connected between the drain terminal of the third PMOS transistor M₃ and a selected connection point between two of the fourth plurality of trimming resistors R₄.

An output terminal V_{ref} is connected to the first end of the fourth plurality of trimming resistors R₄. The trimming of R₃ and/or R₄ causes an adjustment of the output voltage V_{ref} according to Equations (6) to (9):

$$\begin{matrix}\begin{matrix}{I}_{1} = {I}_{2} = {I}_{3} \\ = {I}_{1 a} + {I}_{1 b} = {I}_{2 a} + {I}_{2 b} \\ = Δ {V}_{EB 2} / {R}_{3 A} + {V}_{R 2} / {R}_{2} \\ = Δ {V}_{EB 2} / {R}_{3 A} + [ {V}_{EB 1} + {I}_{2 a} * {R}_{3 B} ] / {R}_{2} where {R}_{2} = {R}_{1} \\ = Δ {V}_{EB 2} / {R}_{3 A} + [ {V}_{EB 1} + \{ Δ {V}_{EB 2} / {R}_{3 A} \} * {R}_{3 B} ] / {R}_{1} \\ = ( {V}_{EB 1} + Δ {V}_{EB 2} * [ {R}_{1} / {R}_{3 A} ] * \{ 1 + {R}_{3 B} / {R}_{1} \} ) / {R}_{1} \\ = ( {V}_{EB 1} + [ {R}_{1} / {R}_{3 A} ] * \{ 1 + {R}_{3 B} / {R}_{1} \} * {V}_{t} * Ln \\ [ ( {I}_{1 a} ) / ( {I}_{2 a} ) * ( {Is}_{2} / {Is}_{1} ) ] ) / R 1\end{matrix} & ( 6 ) \\ {I}_{2 a} = Δ {V}_{EB} / {R}_{3 A} & ( 7 ) \\ \begin{matrix}{I}_{1 a} = {I}_{1} - {I}_{1 b} \\ = {I}_{1} - {V}_{EB 1} / {R}_{1} \\ = ( {V}_{EB 1} + Δ {V}_{EB 2} * [ {R}_{1} / {R}_{3 A} ] * \{ 1 + {R}_{3 B} / {R}_{1} \} ) / {R}_{1} - {V}_{EB 1} / {R}_{1} \\ = ( 1 + {R}_{3 B} / {R}_{1} ) * Δ {V}_{EB 2} / {R}_{3 A} \\ = ( 1 + {R}_{3 B} / {R}_{1} ) * {I}_{2 a}\end{matrix} & ( 8 )\end{matrix}$$

In Equation (8) the bipolar transistors Q₁ and Q₂ have PTAT bias currents. In Equations (6) to (9) R_{3A} is the value of the resistance between selected connected point/closed switch S₁-S₄ and the second PNP bipolar transistor Q₂, and R_{3B} is the value of the resistance between selected connected point/closed switch S₁-S₄ and the second PMOS transistor M₂. In Equation (6) V_{R2} is the voltage across the second resistor R₂. I₁-I₃ are the currents through each of the PMOS transistors. I₁ₐ and I₂ₐ are the currents through the bipolar transistors, and I_{1b} and I_{2b} are the currents through R₁ and R₂ respectively.

$$\begin{matrix}{V}_{ref} = {I}_{3} * {R}_{4} \\ = ( {V}_{EB 1} ( {I}_{1} ) + [ {R}_{1} / {R}_{3 A} ] * \{ 1 + {R}_{3 B} / {R}_{1} \} * {V}_{t} * Ln [ ( {I}_{1 a} ) / \\ ( {I}_{2 a} ) * ( {Is}_{2} / {Is}_{1} ) ] ) * {R}_{4} / {R}_{1} \\ = ( {V}_{EB 1} ( {I}_{1} ) + [ {R}_{1} / {R}_{3 A} ] * \{ 1 + {R}_{3 B} / {R}_{1} \} * {V}_{t} * Ln \\ [ ( 1 + {R}_{3 B} / {R}_{1} ) * ( {Is}_{2} / {Is}_{1} ) ] ) * {R}_{4} / {R}_{1}\end{matrix} \qquad ( 9 )$$

In Equation (9) Vₜ is the thermal voltage (26 mV@ 25 C), I_{S} is the saturation current coefficient of the bipolar devices Q₁ and Q₂,

The PMOS transistors M₁-M₃ may have long channel lengths or an output impedance boost to minimize current differences I₁-I₃ due to different drain voltages and early voltage modulation effect.

According to Equation (9), switches S₁-S₄ trim the ratios R₁/R_{3A} and R_{3B}/R₁ to compensate for the temperature coefficient. By connecting switches S₁-S₄ to high impedance OPAMP input there would be negligible parasitic voltage drop across the switches S₁-S₄.

Switches S₅-S₈ trim the ratio R₄/R₁ to compensate the magnitude of the output voltage V_{ref}. Switches S₅-S₈ do not affect the output voltage since the switches are not in the sense path of the V_{ref} output terminal. The voltage drop across the switches S₅-S₈ will not affect the output voltage as long as there is enough supply voltage headroom.

By connecting the output terminal V_{ref} to a high impedance load, any parasitic voltage drop across the portions of R₄ between the output terminal V_{ref} and the closed switch S₅-S₈ will be negligible. The circuit in FIG. 3 is configured so that the output voltage V_{ref} is independent of the resistance and/or the voltage drop across the switches.

Any other errors in the circuit may be compensated for as is known in the art for example OPAMP offset may be handled by chopping.

A possible application for one or more embodiments is in a CMOS circuit. However it will be readily appreciated by the skilled reader that alternative applications are possible. Equally the skilled reader will appreciate the number of resistor sections and/or switches in each trim circuit can be tailored for the application.

The above example embodiments may be manufactured using fabrication techniques appropriate to the application. The trimming process in each case may occur at manufacturing for each circuit. Once the trimming has been completed the desired switch states may be stored in a Read Only Memory (ROM) or may be permanently set using fuses.

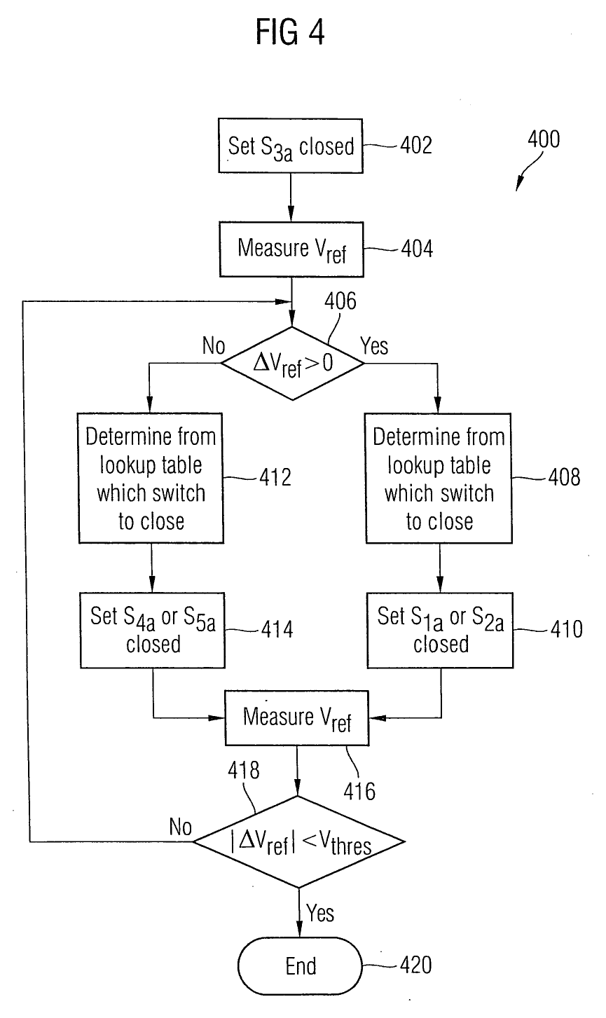

Referring to FIG. 4 an example method 400 of trimming R₄ is shown, which may be employed during manufacturing of the example embodiment shown in FIG. 1 or FIG. 2. The initially closed switch is near the middle of the trim range eg: S₃ₐ (402). The output voltage V_{ref} is measured (404). Based on the deviation ΔV_{ref} of the measured voltage V_{ref} from the desired voltage V_{des} (ΔV_{ref}=V_{ref}−V_{des}) (406), a look up table (408, 412) is used to select the correct trim switch to close (410, 414). The output voltage is again measured (416) and if it is within a threshold range V_{des}±Vₜₕᵣₑₛ around the desired voltage (418), then the trimming process stops (420), otherwise the process is repeated.

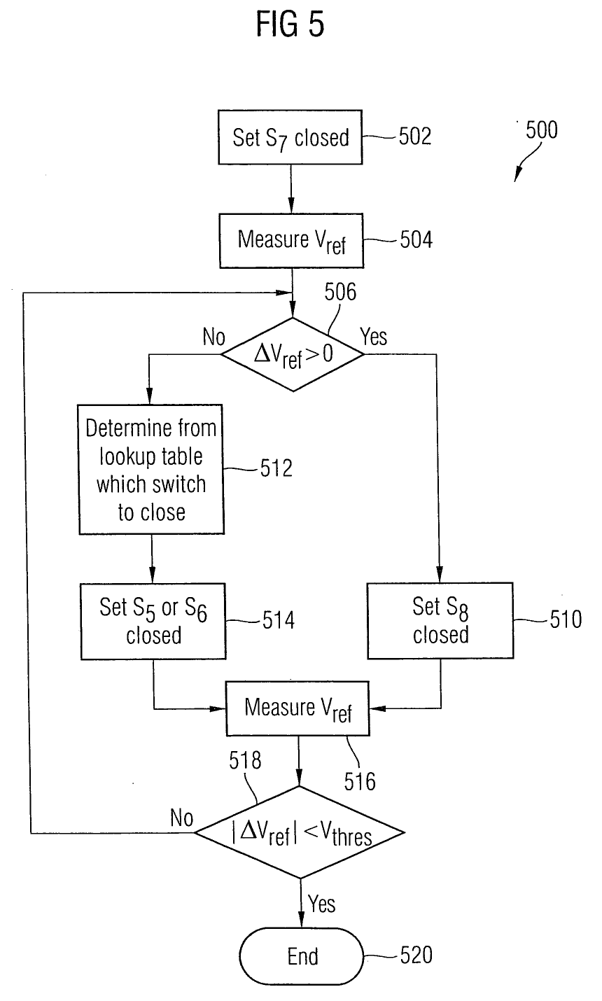

Referring to FIG. 5 an example method 500 of trimming R₄ is shown, which may be employed during manufacturing of the example embodiment shown in FIG. 3. The initially closed switch is near the middle of the trim range eg: S₇ (502). The output voltage V_{ref} is measured (504). Based on the deviation ΔV_{ref} of the measured voltage V_{ref} from the desired voltage V_{des} (ΔV_{ref}=V_{ref}−V_{des}) (506), a look up table (512) is used to select the correct trim switch to close (510, 514). The output voltage is again measured (516) and if it is within a threshold range V_{des}±Vₜₕᵣₑₛ around the desired voltage (518), then the trimming process stops (520), otherwise the process is repeated.

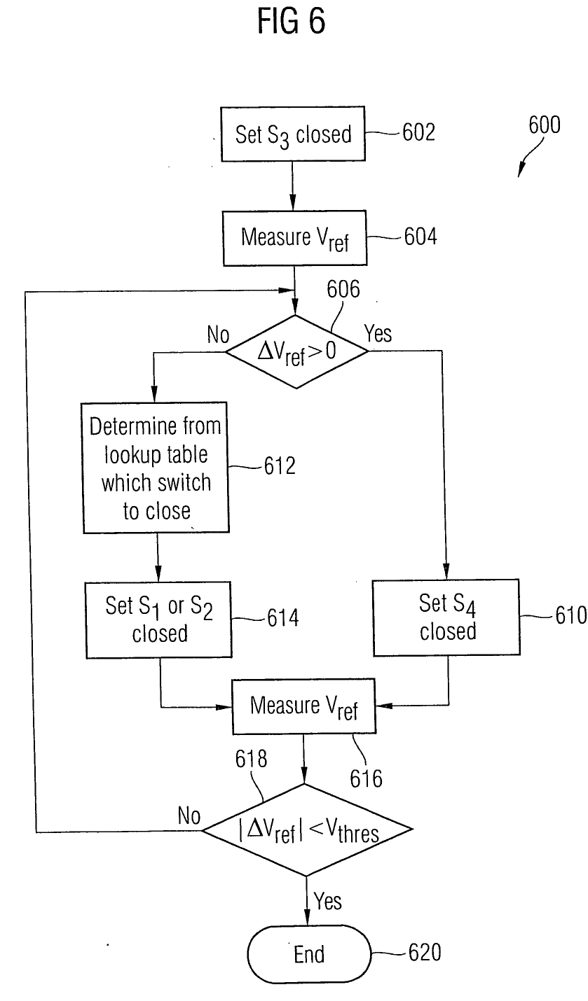

Referring to FIG. 6 an example method 600 of trimming R₃ is shown, which may be employed during manufacturing of the example embodiment shown in FIG. 3. The initially closed switch is near the middle of the trim range eg: S₃ (602). The output voltage V_{ref} is measured (604). Based on the deviation ΔV_{ref} of the measured voltage V_{ref} from the desired voltage V_{des} (ΔV_{ref}=V_{ref}−V_{des}) (606), a look up table (612) is used to select the correct trim switch to close (610, 614). The output voltage is again measured (616) and if it is within a threshold range V_{des}±Vₜₕᵣₑₛ around the desired voltage (618), then the trimming process stops (620), otherwise the process is repeated.

Many variations of the above example embodiments, are possible within the scope of the following claims, as will be clear to a skilled reader.

What is claimed is:

1. A system comprising:
a bandgap reference voltage circuit;
a plurality of trimming resistors;
a plurality of trimming switches to couple the bandgap reference voltage circuit to one or more of the plurality of trimming resistors, and
an output terminal to couple to at least one of the bandgap reference voltage circuit and the plurality of trimming resistors, the output terminal configured to provide a trimmed reference voltage independent of at least one of the resistance of any of the plurality of trimming switches and the voltage across any of the plurality of trimming switches.

2. The system in claim 1, wherein the plurality of trimming resistors have a first end and a second end, the first end being coupled to the bandgap reference voltage circuit.

3. The system in claim 2, further comprising a second plurality of trimming switches to couple one or more of the plurality of trimming resistors to the output terminal.

4. The system in claim 2, wherein the output terminal is coupled to the second end.

5. The system in claim 1, wherein the plurality of trimming resistors have a first end and a second end, the first end being coupled to ground.

6. The system in claim 5, wherein the output terminal is coupled to the second end.

7. An apparatus comprising:
a bandgap reference voltage circuit having at least one bandgap terminal;
a plurality of trimming resistors coupled in series;
a first plurality of trimming switches to couple a first bandgap terminal to a selected connection point between two of the plurality of trimming resistors to adjust the reference voltage, and
an output terminal coupled in series with the selected connection point and configured to provide a trimmed reference voltage.

8. The apparatus in claim 7, wherein the plurality of trimming resistors have a first end and a second end, the first end being coupled to a second bandgap terminal.

9. The apparatus in claim 8, further comprising a second plurality of trimming switches to couple between the selected connection point and the output terminal.

10. The apparatus in claim 8, wherein the output terminal is coupled to the second end.

11. The apparatus in claim 7, wherein the plurality of trimming resistors have a first end and a second end, the first end being coupled to ground.

12. The apparatus in claim 11, wherein the output terminal is coupled to the second end.

13. The apparatus in claim 7, wherein said first plurality of trimming switches comprises one of a multi-way switch or a multiplexer.

14. The apparatus in claim 9, wherein said first plurality of trimming switches and said second plurality of trimming switches comprise one of a double pole multi-way switch or a pair or multiplexers configured to be synchronized.

15. An apparatus comprising:
an operational amplifier having a positive input terminal, a negative input terminal and an OPAMP output;
a first resistance coupled to the positive input terminal;
a second resistance coupled to the negative input terminal;
a third resistance coupled between the negative input terminal and the first resistance;
a first PNP bipolar transistor having a first collector, first emitter and first base, the first emitter coupled to the positive input terminal, the first collector and the first base coupled to ground;
a second PNP bipolar transistor having a second collector, second emitter and second base, the second emitter coupled to the second resistance, the second collector and the second base coupled to ground; and
a fourth resistance coupled between the OPAMP output, and the first and third resistance.

16. The apparatus claimed in claim 15, wherein the fourth resistance comprises a first plurality of trimming resistors, having a first end and a second end, the first end being coupled to the first and third resistance, the apparatus further comprising a first plurality of trimming switches to couple the OPAMP output to a selected connection point between two of the plurality of trimming resistors.

17. The apparatus claimed in claim 16, further comprising:
an output terminal to provide a reference voltage, and
a second plurality of trimming switches coupled between the selected connection point and the output terminal.

18. The apparatus claimed in claim 16, further comprising:
an output terminal to provide a reference voltage and coupled to said second end.

19. An apparatus comprising:
an operational amplifier having a positive input terminal, a negative input terminal and an OPAMP output;
a first PMOS transistor having a first drain, a first source and a first gate, the first drain coupled to the negative input terminal, the first source coupled to a supply, and the first gate coupled to the OPAMP output;
a first resistance coupled to the negative input terminal;
a first PNP bipolar transistor having a first collector, a first emitter and a first base, the first emitter coupled to the negative input terminal, the first collector and the first base coupled to ground;
a second PMOS transistor having a second drain, a second source and a second gate, the second source coupled to the supply and the second gate coupled to the OPAMP output;
a second resistance coupled to the second drain;
a third plurality of trimming resistors having a first end and a second end, the first end of the third plurality of trimming resistors coupled to the second drain;
a first plurality of trimming switches coupled the positive input terminal to a selected connection point between two of the third plurality of trimming resistors;
a second PNP bipolar transistor having a second collector, a second emitter and a second base, the second emitter coupled to the second end of the third plurality of trimming resistors, the second collector and the second base coupled to ground; and
a third PMOS transistor having a third drain, a third source and a third gate, the third source coupled to the supply and the third gate coupled to the OPAMP output;
a fourth plurality of trimming resistors having a first end and a second end, the second end of the fourth plurality of trimming resistors coupled to ground;
a second plurality of trimming switches coupled to the third drain to a selected connection point between two of the fourth plurality of trimming resistors; and
an output terminal coupled to the first end of the fourth plurality of trimming resistors and provide a reference voltage.

20. In a CMOS circuit, the improvement comprising the system in claim 1.

21. A method comprising:
providing a bandgap reference voltage circuit;
providing a plurality of trimming resistors;
providing a plurality of trimming switches coupled to the bandgap reference voltage circuit to a selected connection point between two of the plurality of trimming resistors;
providing an output terminal to connect to at least one of the bandgap reference voltage circuits and the plurality of trimming resistors; and
selecting one trimming switch to close from said plurality of trimming switches to trim the voltage at the output terminal.

22. The method in claim 21, wherein selecting one trimming switch comprises:
energizing the circuit with an initial trimming switch closed;
measuring the output voltage;
determining one trimming switch to close based on the magnitude and/or polarity of the difference between the measured output voltage to the desired output voltage; and
closing the selected switch.
